(19) United States
(12) Patent Application Publication
(10) Pub. No.: US 2021/0362417 A1
(43) Pub. Date: Nov. 25, 2021

(54) PACKAGED 3-DIMENSIONAL MODELING POWDER MATERIAL AND 3-DIMENSIONAL MODELING SYSTEM

(71) Applicant: CANON KABUSHIKI KAISHA, Tokyo (JP)

(72) Inventors: Yasuhiro Sekine, Kanagawa (JP); Yasushi Shimizu, Kanagawa (JP); Nobuhiro Yasui, Kanagawa (JP); Shunsuke Murakami, Tokyo (JP); Kanako Oshima, Tokyo (JP)

(21) Appl. No.: 17/316,918

(22) Filed: May 11, 2021

(30) Foreign Application Priority Data
May 25, 2020 (JP) 2020-090418
Apr. 9, 2021 (JP) 2021-066808

(51) Int. Cl. B29C 64/255; B29C 64/153; B29C 64/314; B29C 64/321; C08J 7/048; B33Y 30/00; B33Y 40/10

(52) U.S. Cl. CPC B29C 64/255; B29C 64/153; B29C 64/314; B29C 64/321; C08J 7/048; C08J 2329/04; B33Y 40/10; C08J 2323/08; C08J 2327/08; C08J 2333/20; B33Y 30/00

(57) ABSTRACT

The packaged 3-dimensional modeling powder material, including 3-dimensional modeling powder material including plural types of particles, and a storage container configured to contain the modeling powder material in an inside of the storage container in a pressured state.

### BACKGROUND OF THE INVENTION

### Field of the Invention

The present invention relates to a packaged powder material including powder material to be used for 3-dimensional modeling (hereinafter referred to as “3-dimensional modeling powder material”) to obtain a 3-dimensional object by emitting a laser to predetermined portions of the powder material and sintering or melting and solidifying the powder material, and a container.

### Description of the Related Art

These days, because a solid object can be directly formed by CAD data in additive processes by 3-dimensional modeling apparatuses, 3-dimensional modeling apparatuses are applied to various technology fields. Especially, the powder bed fusion type of the 3-dimensional modeling apparatuses attract attention because it is possible to form 3-dimensional objects with delicate members in high precision.

In the powder bed fusion types of the 3-dimensional modeling apparatuses, as disclosed in Japanese Patent Application Laid-Open No. 2010-37599, a 3-dimensional object is formed by thinly laying 3-dimensional modeling powder material on a modeling stage, emitting a laser beam to the thinly laid powder material based on 3-dimensional modeling data to be formed and sintering, or melting and solidifying the thinly laying powder material.

In the powder bed fusion types of the 3-dimensional modeling, a 3-dimensional modeling powder material consisting of powder as raw materials of a solid modeling object. It is prepared to achieve the features required for the solid modeling object because ingredients, particle diameters, and particle shapes of the powder directly affects a final shape and properties of the solid modeling object.

In the case where modeling powder material is powder mixture material with plural types of powder particles, it is extremely important to supply powder material on a modeling stage in a state where homogeneity in chemical perspective and uniformity in physical perspective of powder mixture material are maintained. If 2-dimensional or 3-dimensional dispersions in compositions and/or particle diameters are caused for powder mixture material layered on the modeling stage, 2-dimensional or 3-dimensional unevenness occurs in behaviors of melting and solidifying powder material of modeling processes. This is a cause to result in unevenness in compositions, accuracy degradations in dimensions and dispersions in qualities of a solid modeling object.

As a means of keeping homogeneity and uniformity of powder mixture material in modeling processes, it is one option to provide a mechanism to agitate powder mixture material prior to supplying it onto a modeling stage. If, however, powder mixture material has plural types of particles in which differences in specific gravities and differences in particle diameters are large, it is difficult to maintain homogeneity and uniformity of powder mixture material only by agitating powder mixture material. This is a problem to maintain stable quality of a solid modeling object.

In this context, in the result of investigation and study of processes from manufacturing 3-dimensional modeling powder material as powder mixture material used for 3-dimensional modeling process to supplying 3-dimensional modeling powder material onto a modeling stage of 3-dimensional modeling apparatus, a problem is investigated in the process of packaging, transporting and handling powder mixture material after the powder mixture material is manufactured. That is, even though powder mixture material keeps high uniformity in manufacturing process, it is found that homogeneity and uniformity of powder mixture material in the modeling process degrade because vibrations applied to powder mixture material in storage, transportation and handling after the manufacturing cause composition distribution of powder mixture material.

In order to solve this problem, it is required, a good way for storing and transporting 3-dimensional modeling powder material, and supplying 3-dimensional modeling powder material to 3-dimensional modeling apparatus in the state where homogeneity and uniformity of powder mixture material in the manufacturing process of 3-dimensional modeling powder material are kept.

### SUMMARY OF THE INVENTION

An aspect of the present invention is a packaged 3-dimensional modeling powder material to provide powder mixture material into 3-dimensional modeling process in the state where evenness in compositions and particle diameters in manufacturing are kept, so that accuracy in dimensions and dispersions in qualities of a solid modeling object with high reliability are achieved.

Another aspect of the present invention is a packaged 3-dimensional modeling powder material, including 3-dimensional modeling powder material including plural types of particles, and a storage container configured to contain the 3-dimensional modeling powder material in an inside of the storage container in a compressed state.

A further aspect of the present invention is a 3-dimensional modeling system including a 3-dimensional modeling apparatus including a powder material supply module configured to contain a 3-dimensional modeling powder material, a modeling module configured to form a 3-dimensional object by sintering, or both melting and solidifying the 3-dimensional modeling powder material; and a powder material transfer unit configured to supply the 3-dimensional modeling powder material from the powder material supply module to the modeling module, and a packaged 3-dimensional modeling powder material including the 3-dimensional modeling powder material including plural types of particles, and a storage container configured to contain the 3-dimensional modeling powder material in an inside of the storage container in a compressed state, and wherein prior to supplying the 3-dimensional modeling powder material, the packaged 3-dimensional modeling powder material is placed in the powder material supply module of the 3-dimensional modeling apparatus after releasing the compressed state.

Further features of the present invention will become apparent from the following description of exemplary embodiments with reference to the attached drawings.

### BRIEF DESCRIPTION OF THE DRAWINGS

FIG. 1A shows the powder material container in the first embodiment.

FIG. 1B shows the powder material container in which 3-dimensional powder material is filled in the first embodiment.

FIG. 1C shows the packaged 3-dimensional modeling powder material in the first embodiment.

FIG. 2A shows the powder material container in the second embodiment.

FIG. 2B shows the powder material container in which 3-dimensional powder material is filled in the second embodiment.

FIG. 2C shows the packaged 3-dimensional modeling powder material in the second embodiment.

FIG. 3A shows the powder material container in the third embodiment.

FIG. 3B shows the powder material container in which 3-dimensional powder material is filled in the third embodiment.

FIG. 3C shows the packaged 3-dimensional modeling powder material in the third embodiment.

FIG. 4A shows the powder material container with the shell box in the fourth embodiment.

FIG. 4B shows the powder material container with the shell box in a state where 3-dimensional powder material is filled in the fourth embodiment.

FIG. 4C shows the packaged 3-dimensional modeling powder material in the fourth embodiment.

FIG. 5 shows the modeling stage and the powder material supply stage in the powder bed fusion type of the 3-dimensional modeling apparatus.

FIGS. 6A and 6B show behaviors in the operation of the modeling module and the powder material supply module the 3-dimensional modeling apparatus.

FIG. 7A shows the state of the powder material supply stage on which a cutting blade is provided, before the placement of the packaged 3-dimensional modeling powder material.

FIG. 7B shows the state of the powder material supply stage on which a cutting blade is provided, after the placement of the packaged 3-dimensional modeling powder material.

FIG. 8 shows the powder material container in the fifth embodiment.

FIG. 9A shows the main portion of 3-dimensional modeling system before the packaged 3-dimensional modeling powder material in the fifth embodiment is provided to the powder material supply module.

FIG. 9B shows the main portion of 3-dimensional modeling system into which the packaged 3-dimensional modeling powder material in the fifth embodiment is provided and after compression in the packaged 3-dimensional modeling powder material is released.

### DESCRIPTION OF THE EMBODIMENTS

It is described below, embodiments to which the present invention is applied, in the case where the modeling powder material for the powder bed fusion type is powder mixture material including plural types of particles. Hereinafter, “powder mixture material including plural types of particles” is defined as a term including powder material having particles whose compositions or components are respectively different, and powder material having plural peak values in the measurement of average particle diameters in the powder material. In the present application, they are respectively defined, modeling powder material as aggregation of powder particle for modeling, a powder material container as a case or a pouch member that allows containing modeling powder material and the packaged powder material as the container in which powder material is contained.

In the powder bed fusion type, a void ratio of a solid modeling object tends to be higher than molded articles formed with general bulk materials because material ratio in the volume of the solid modeling object is relatively low. There are many cases in which a mechanical strength of a solid modeling object made in the powder bed fusion type of modeling apparatus is lower than that of articles formed with general bulk materials. Therefore, in the application in which high durability is required, it is required to obtain a solid object whose density-highness is enhanced.

As a means of enhancing density-highness of a solid object, there is a means of increasing density of a solid object by infilling spaces in powder materials forming a powder material layered modeling object. For example, a space-infilling ratio can be increased by mixing modeling powder material including two types of particles having different average diameters which are larger diameters and smaller diameters. In the assumption where all of powder particles include spherical particles, the maximum density in the 3-dimensional space-infilling with one type of particles reaches about 74% at most with regard to density in the case of face-centered cubic lattice infilling. The maximum density in the 3-dimensional space-infilling, however, can be increased to about 93% in principle by means of two types of spherical particles whose diameters can be categorized into larger and smaller and diameters ratio are to be an infinite. The particles with relatively smaller diameters can be entered into gaps between the particles with relatively larger diameters by making the particle diameters difference between larger and smaller diameters be sufficiently large.

In addition, trials are attempted to improve physical properties, modeling mechanical accuracies and modeling speeds of the solid object, by composing the modeling powder material with plural and different types of particles whose compositions or components are different with each other and making the particles function.

For example, there are example options to mix the resin particles and glass particles to improve the elastic modulus of the solid object, and to mix the ceramics particles and metal particles to improve the toughness of the solid object. In the case of mixing the glass particles into the resin material, the specific gravity of the resin material ranges about 1 to 1.7, while the specific gravity of the glass has about 2.5. In the case of mixing the metal material particles into the ceramic material, the specific gravity of the ceramic material ranges about 2.5 to 3.5, while the specific gravities of metals except for aluminum and titanium are equal to about 7 or more. In these kinds of powder mixture material, the compositions of the powder mixture material easily vary in the inside of powder material because powder material with particles whose specific gravity is relatively large tends to move to a lower position when the powder material is transported or handled.

Furthermore, in the modeling by means of the powder material including ceramics as a main component, in order to enhance the modeling speed or modeling mechanical accuracies, it is preferable to use the powder mixture material in which powder material having high light absorption ability for laser light emitted in the modeling process is added. For example, the use of the powder mixture material in which Al₂O₃ powder, Gd₂O₃ powder or Tb₄O₇ powder are mixed as modeling powder material provides good modeling speed and good modeling accuracy because Tb₄O₇ powder absorbs laser light. In this case, in order to obtain a necessary fluidity for forming powder material floor, the particle diameters of Al₂O₃ powder, Gd₂O₃ powder are to be preferably 20 to 30 micrometers, while the particle diameter of Tb₄O₇ powder for enrolling the absorption of laser light is to be preferably 3 to 4 micrometers. Herein, a particle diameter is a central value adopted among values obtained as diameters corresponding to circles from areas projected on a plane for 1000 and more respective particles in microscope photographs of powder materials.

For these kinds of mixture powder materials having plural components, it is possible to industrially manufacture mixture powder material to make their particles be within dispersion ranges statistically allowable in modeling because of accumulated know-how in a long history in variety industry fields including a chemical industry and a food industry.

In the case of mixture powder material including plural types of particles with different particle diameters with each other, however, it is hard to maintain a mixture state of the mixture powder material in a uniform because smaller particles descend to a lower portion and larger particles come together at an upper portion in a vertical direction by vibrations caused in transportations and handlings, as a granular convection, sometimes called as brazil nuts effect. In the case of mixture powder material including plural types of particles with different specific gravities, it is difficult to maintain a mixture state of the mixture powder material in a uniform because particles with larger specific gravities descend to a lower portion and particles with smaller specific gravities come together at an upper portion in a vertical direction by vibrations.

The embodiment of the present invention is a packaged 3-dimensional modeling powder material that is capable to supply 3-dimensional modeling powder material to a 3-dimensional modeling apparatus while maintaining a desired mixture state made in a manufacturing process. The 3-dimensional modeling powder material in the packaged 3-dimensional modeling powder material in the present invention is mixture powder material having plural types of particles each of which has different specific gravities according to each of the types of the particles. Also, the 3-dimensional modeling powder material in the packaged 3-dimensional modeling powder material in the present invention is powder mixture material having plural types of particles each of which has different particle diameters according to each of the types of the particles.

### First Embodiment

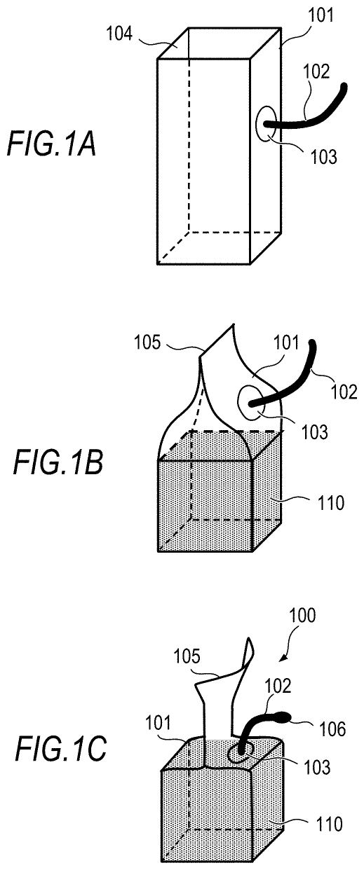

With reference to FIGS. 1A to 1C, it is described, the packaged 3-dimensional modeling powder material 100 as the first embodiment. The packaged 3-dimensional modeling powder material 100 includes 3-dimensional modeling powder material 110 and the storage container 101 in which the 3-dimensional modeling powder material is contained in an inside of the storage container 101. In this embodiment, it is described, a method to supply the 3-dimensional modeling powder material 110 as powder mixture material including plural types of particles while maintaining a desired state mixed in its manufacturing process. FIGS. 1A to 1C represent the storage container 101 in the first embodiment. FIG. 1A shows the state of the storage container 101 before the 3-dimensional modeling powder material 110 is filled in the storage container 101. FIG. 1B shows the state of the storage container 101 in which the 3-dimensional modeling powder material 110 is enclosed in an inside of the storage container 101 to make a package state by sealing the opening inlet 104 with thermal fusion bonding. FIG. 1C shows the state of the packaged 3-dimensional modeling powder material 100 in which the 3-dimensional modeling powder material 110 is contained in the inside of the storage container 101 in a compressed (pressured) state by introducing the 3-dimensional modeling powder material 110 in the storage container 101 and then depressurizing the inside of the storage container 101.

The storage container 101 has an outer portion that defines a space inside the storage container 101. The space defined inside the storage container 101 by the outer portion stores the 3-dimensional modeling powder material 110 including plural types of particles as the powder mixture material that is a raw material for 3-dimensional modeling. At least part of the outer portion, a part or the whole part, of the storage container 101 is deformable (displaceable). For example, in this embodiment, the outer portion of the storage container 101 is made of a flexible material, and the whole part of the outer portion has a flexibility. The exhaust pipe 102 and the filter 103 are provided on the storage container 101. The exhaust pipe 102 is fluidly connectable to an exhaust apparatus (not-shown). The 3-dimensional modeling powder material 110 to be filled in the storage container 101 is prepared in a desired mixture state by a not-shown powder material manufacture apparatus in advance.

The upper portion of the storage container 101 has the opening inlet 104. The 3-dimensional modeling powder material 110 is introduced into the inside of the storage container 101 through the opening inlet 104 as shown in FIG. 1A. After the 3-dimensional modeling powder material 110 is filed into the inside of the storage container 101 through the opening inlet 104, the opening inlet 104 is closed by a pressure bonding with a thermal fusion or ultrasonic fusion to form a sealing portion 105 and close the inside of the storage container 101 (FIG. 1B).

After the 3-dimensional modeling powder material 110 is introduced into the inside of the storage container 101, the exhaust pipe 102 is fluidly connectable to an exhaust apparatus (not-shown), an air in the storage container 101 is exhausted through the exhaust pipe 102. The inside of the storage container 101 is degassed to keep a pressure less than 1×10⁵ Pa according to the gas permeability ratio of the material of the member to isolate the 3-dimensional modeling powder material 110 from atmosphere. In a state in which the inside of the storage container 101 is degassed by this degasification, the exhaust pipe 102 is separated off at the fusion bonding portion 106 by the thermal fusion bonding. A check valve (not-shown) may be provided in the exhaust pipe 102. In the case where the exhaust pipe 102 has a check valve, it is possible to prevent an air flow caused in the exhaust pipe 102 by not-intended back-flow from entering into the storage container 101. Because the storage container 101 has a flexibility, the internal pressure of the storage container 101 is less than the external pressure of the storage container 101 by the degasification of the inside of the storage container 101 to form the packaged 3-dimensional modeling powder material 100 in which a depressurized state is kept (FIG. 1C).

By lowering the internal pressure of the storage container 101 than the external pressure of the storage container 101, a portion at which an air exists, inside the storage container 101 is yielded to deform (displace) the outer portion of the storage container 101 having a flexibility so that the outer portion brings into strongly contact with the 3-dimensional modeling powder material 110. The deformation (displacement) of the outer portion of the storage container 101 pressures the 3-dimensional modeling powder material 110 so that the 3-dimensional modeling powder material 110 is compressed. In this embodiment, herein, although it is exemplified that the exhaust pipe 102 is sealed by a thermal fusion bonding, a valve may be provided in the exhaust pipe 102 to close the valve after the completion of the degasification inside the storage container 102 and keep the depressurized state.

In the degasification, an air inside the storage container 101 is exhausted through the exhaust pipe 102, while the 3-dimensional modeling powder material 110 is not discharged into the exhaust pipe 102 because the filter 103 is provided at the periphery of the exhaust pipe 102 on the storage container 102. The filter 103 provided thereon is a filter that an air is allowed to permeate and each of the plural types of particles as components of the 3-dimensional modeling powder material 110 is not allowed to permeate. Also, the filter 103 is provided at not only a tip of the exhaust pipe 102 but also a periphery of the exhaust pipe 102 to form a part of the storage container 101 so that the exhaust paths of a gas are decentralized to the whole of the filter 103.

In general, in the case where a surface of powder material contacts an air flow whose velocity is a certain flow velocity or more, the powder material is swept by the air flow. In the case where the powder material has the distribution of particle diameters and/or densities, the powder material is deposited to be separated and layered depending on each of the particle diameters and/or densities of the particles. Therefore, even though a desired mixture state is achieved in the granulation process to make powder material and the mixture process, the mixture state at the surface of the powder material may be transmuted by the air flow flowing on the surface of the powder material in the statically placed state.

In order to avoid the transmutation of the mixture state by this phenomenon, in this embodiment, it is prevented to form a specific flow path when an air is exhausted by deconcentrating the air flow paths to the whole filter surface. By preventing the specific flow path from being formed, the transmutation of the mixture state on the surface of the powder material can be prevented in the end because the flow velocity of an air flow on the surface of the powder material can be reduced not to sweep the powder material.

The storage container 101, at least a wall portion of the storage container 101, is made of a film-type resin having a low gas permeability ratio and a flexibility. A film thickness determined according to gas permeability ratio of the film-type resin material is applied to the storage container 101. As examples of a resin film having low gas permeability ratio, ethylene-vinyl alcohol copolymerization, polyvinylidene chloride and polyacrylonitrile can be applied. In representative example, at least one of those material can be used. Also, even though a resin material having a higher gas permeability ratio than the above-mentioned resin material can be used by increasing a resin film thickness or coating the surface of the film-type resin with a coating layer having a gas-barrier property. As examples of the coating layer, a metal coating layer, a ceramic coating layer, a low gas-permeability resin coating layer can be applied. The aforementioned film-type of resin having a flexibility includes a film laminated with plural thin films.

Next, it is explained, the requirement value of the gas permeability for the storage container 101. A gas permeability ratio of the film-type of resin is desired to be equal to or less than 50 (cc/m²)/day. Although the compositions of the atmospheric air are about 80% of nitrogen and about 20% of oxygen, because the gas permeability of oxygen is higher than that of nitrogen. An oxygen permeability ratio of the film-type of resin is desired to be equal to or less than 50 (cc/m²)/day.

This value can be calculated from a time period for which it is required for a gas to permeate through walls of the storage container 101. The gas in this calculation is defined as a gas whose volume corresponds to the total volume of spaces existing in gaps between particles of powder material in the case where powder material with 10 kg (the bulk density is 3 (g/m²)/day) is sealed in the storage container 101. In the case where the storage period of the 3-dimensional modeling powder material 110 is assumed as 6 months, the oxygen permeability ratio of the film-type of resin may be equal to or less than 50 (cc/m²)/day to keep the depressurized state in the inside of the storage container 101.

Also, oxygen absorption agent as deoxygenating agent for absorbing oxygen can be sealed with 3-dimensional modeling powder material 110 in the storage container 101. The oxygen absorption agent is to be preferably provided to contact the inner surface of the storage container 101 so as not to result in bad influence in modeling by mixture with 3-dimensional modeling powder material 110. By enclosing the oxygen absorption agent in the storage container 101, because oxygen remaining in spaces existing in gaps between particles of powder material and permeating through the walls of the storage container 101 can be removed to allow to elongate a time period for which the inside of the storage container 101 can be kept in a depressurized state.

In the packaged 3-dimensional modeling powder material 100 in this embodiment, the 3-dimensional modeling powder material 110 is decompressed by the walls of the storage container 101 by degassing the inside of the storage container 101 in which the 3-dimensional modeling powder material 110 is enclosed and keeping it in a depressurized state. By this, the whole part of the 3-dimensional modeling powder material 110 can be maintained in the mixture state made in the manufacturing process because the particles in the 3-dimensional modeling powder material 110 strongly contact with each other. Even in the case where the movement of the particles is observed at a local portion in the packaged 3-dimensional modeling powder material 100, the relative position relationship between the particles is almost fixed in a whole view. By this, the flow of particles of the 3-dimensional modeling powder material 110 in the storage container 101 caused in transportation can be restricted.

In the case of supplying the 3-dimensional modeling powder material 110 sealed in the storage container 101 into a 3-dimensional modeling apparatus, it is set into the material container unit of the 3-dimensional modeling apparatus by opening the sealing portion 106. In this process, although the mixture state made in the manufacturing process may slightly changes, the influence affected in modeling is less than unevenness caused by vibration in transportation.

As above, by transporting and storing the 3-dimensional modeling powder material 110 as the packaged 3-dimensional modeling powder material 100 shown in FIG. 1C, modeling powder materials can be provided to users of 3-dimensional modeling apparatuses in the mixture state in which powder material is mixed in manufacturing process to be within dispersion ranges statistically allowable in modeling. And then, users of the 3-dimensional modeling apparatuses can use the 3-dimensional modeling powder material 110 while keeping the state of composition in manufacturing process and uniformity of the particles. In the end, accuracy in dimensions, dispersions in qualities and reliabilities in qualities of a solid modeling object are enhanced. Manufacturers of powder materials can provide modeling powder materials in a state in which uniformity in the mixture state of plural components is kept to users by treating the 3-dimensional modeling powder material 110 as the packaged 3-dimensional modeling powder material 100 in which the 3-dimensional modeling powder material 110 is stored in the storage container 101.

### Second Embodiment

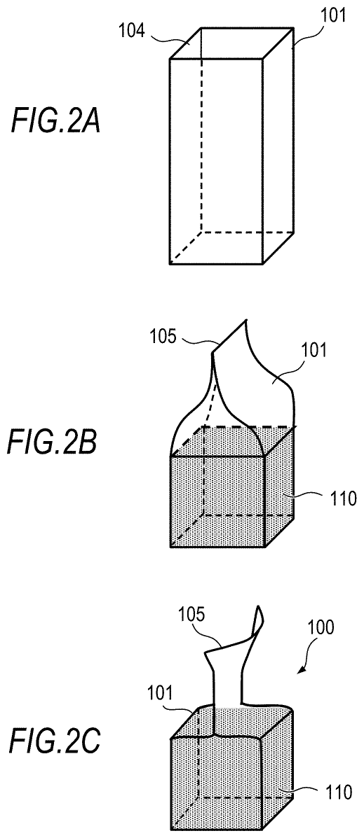

With reference to FIGS. 2A to 2C, it is described, the packaged 3-dimensional modeling powder material 100 as the second embodiment. The storage container 101 in the second embodiment has the same structure as that in the first embodiment, except for the constituent in which the exhaust pipe 102 and the filter 103 are not provided. Therefore, hereinafter, the different portions from the first embodiment are explained, while the common portions as the first embodiment are spared.

The difference of the packaged 3-dimensional modeling powder material 100 between in this embodiment and in the first embodiment is the difference of the method to enclose the 3-dimensional modeling powder material 110 into the storage container 101. In this embodiment, the 3-dimensional modeling powder material 110 is introduced into the storage container 101 under a vacuum ambient state and packed. FIG. 2A shows the state of the storage container 101 before the 3-dimensional modeling powder material 110 is introduced in the storage container 101. FIG. 2B shows the state where the storage container 101 in which the 3-dimensional modeling powder material 110 is enclosed is placed under the vacuum ambient state and the opening inlet 104 is sealed. FIG. 2C shows the state of the packaged 3-dimensional modeling powder material 100 in which after the 3-dimensional modeling powder material 110 is introduced in the inside of the storage container 101 and a clean-dry air is introduced into ambience of the storage container 101 to recover a pressure of the inside of the storage container 101 to atmospheric pressure.

The 3-dimensional modeling powder material 110 is prepared in a desired mixture state by a not-shown powder material manufacture apparatus. The introduction of the 3-dimensional modeling powder material 110 into the storage container 101 through the opening inlet 104 provided at the upper portion of the storage container 101 is the same as that of the first embodiment. The storage container 104 in which the 3-dimensional modeling powder material 110 is contained is placed in a vacuum chamber (not-shown) and the air in the vacuum chamber is exhausted under the state in which the opening inlet 104 is opened, to a pressure in the vacuum chamber less than 10⁵ Pa (FIG. 2A). Next, as shown in FIG. 2B, the opening inlet 104 is closed and sealed while keeping the vacuum state in the vacuum chamber to form the sealing portion 105 and close the storage container 101.

FIG. 2C shows the state where after the state in FIG. 2B, a clean-dry air is introduced into the vacuum chamber (not-shown) to recover the inside of the vacuum chamber to the atmospheric pressure. Because the inside of the storage container 101 is degassed into a vacuum state, once the inside of the vacuum chamber is released to the atmospheric pressure under the state in which the opening inlet 104 is closed and sealed, the inside of the storage container 101 becomes the depressurized state against the ambience. Therefore, the storage container 103 having a flexibility deforms so that the 3-dimensional modeling powder material 110 is compressed by the external pressure through the storage container 101. By that, particles included in the 3-dimensional modeling powder material 110 strongly contacts with each other and prevents the relative position relationship between the particles from transmuting to be able to form the packaged 3-dimensional modeling powder material 100 in which the mixture state of the 3-dimensional modeling powder material 110 made in the manufacturing process is maintained.

That is, in this embodiment, by lowering the internal pressure of the storage container 101 than the external pressure of the storage container 101, the deformations of the walls of the storage container 101 is caused and the relative position relationship between the particles included in the 3-dimensional modeling powder material 110 is fixed.

In this embodiment, even in the case where the movement of the particles included in the 3-dimensional modeling powder material 110 is observed at a local portion, the relative position relationship between the particles is almost fixed in a whole view.

The method to supply the 3-dimensional modeling powder material 110 in the packaged 3-dimensional modeling powder material 100 to a 3-dimensional modeling apparatus is the same as that of the first embodiment.

By transporting and storing the 3-dimensional modeling powder material 110 by the packaged 3-dimensional modeling powder material 100 of this embodiment, in the manufacturing process of a solid modeling object, mixture powder material can be provided to users of 3-dimensional modeling apparatuses in the mixture state within dispersion ranges statistically allowable in modeling. And then, the users of 3-dimensional modeling apparatuses can use mixture powder material while keeping the state of composition in manufacturing process of the 3-dimensional modeling powder material 110 and uniformity of the particles. In the end, accuracy in dimensions, dispersions in qualities and reliabilities in qualities of a solid modeling object can be enhanced.

### Third Embodiment

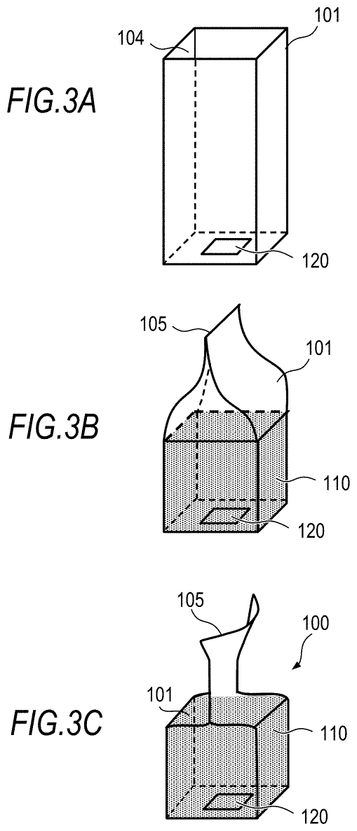

With reference to FIGS. 3A to 3C, it is described, the packaged 3-dimensional modeling powder material 100 as the third embodiment. The storage container 101 in the third embodiment has the same structure as that in the second embodiment, except for the constituent in which the oxygen absorption agent 120 is provided in the storage container 101. Hereinafter, the different portions from the second embodiment are explained, while the common portions as the second embodiment are spared.

FIGS. 3A to 3C show the storage container 101 in which the oxygen absorption agent 120 is provided in the storage container 101. FIG. 3B shows the state where after the 3-dimensional modeling powder material 110 and the oxygen absorption agent 120 are enclosed into the storage container 101 and the storage container 101 is compressed from the upper side of the storage container 101 with a mechanically provided pressure while exhausting the air in the storage container 101 to the external. This is the state in which the opening inlet 104 is closed and sealed after most of the air is exhausted with the pressure. In the process shown in FIG. 3B, the inside of the storage container 101 is almost in an atmospheric pressure and not in a degasification state. In the state in which the air inside the storage container 101 is exhausted to mechanically bring the storage container 101 into contact with the 3-dimensional modeling powder material 110, about ⅕ of oxygen to the volume corresponding to the spaces existing in gaps between particles of powder material remains in the spaces.

FIG. 3C shows the state of the packaged 3-dimensional modeling powder material 100 in which after the storage container 101 is closed and sealed, the inside of the storage container 101 is depressurized by reducing oxygen in the storage container 101 with the oxygen absorption agent 120. In this state, the internal pressure of the storage container 101 is less than the external pressure of the storage container 101 so that the storage container 101 deforms and the 3-dimensional modeling powder material 110 is compressed and the relative position of the particles of powder material is fixed.

Because the preparations of an apparatus for degassing the inside of the storage container and an exhaust pipe and a filter onto the storage container 101 are unnecessary, this embodiment has advantages in the aspects of costs and man-hours and brings the same effect as those of the first embodiment and the second embodiment.

### Fourth Embodiment

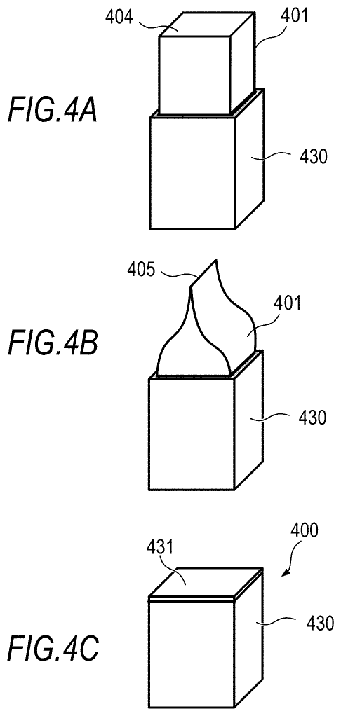

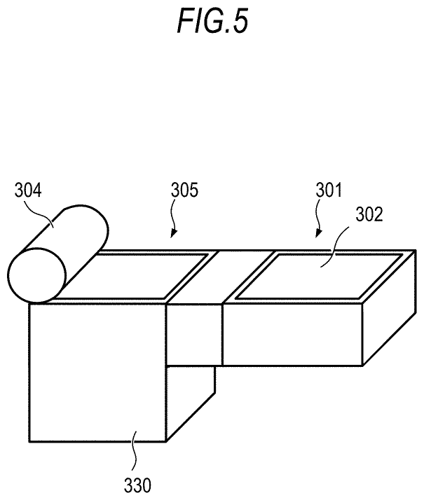

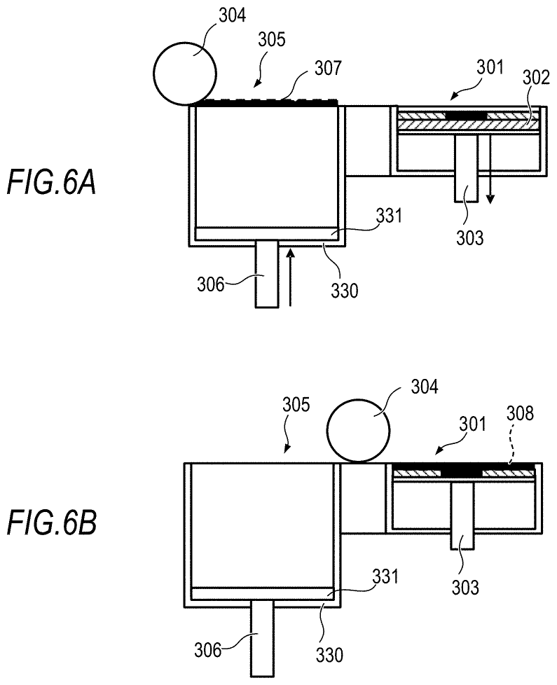

With reference to FIGS. 4A to 6B, it is described, the packaged 3-dimensional modeling powder material 400 as the fourth embodiment. The packaged 3-dimensional modeling powder material 400 includes a 3-dimensional modeling powder material (not-shown) and a storage container 401 in which the 3-dimensional modeling powder material (not-shown) is contained in the inside of the storage container 401. The 3-dimensional modeling powder material (not-shown) is the same as those in the first embodiment to the third embodiment. FIGS. 4A to 4C represent the state in which powder material is closed and sealed as the packaged 3-dimensional modeling powder material 400 in the fourth embodiment. FIG. 5 shows the modeling module 301 and powder material supply module 305 of the powder fusion bed type of the 3-dimensional modeling apparatus. FIGS. 6A and 6B represent the transportation of the powder material between the modeling module 301 and the powder material supply module 305 of the 3-dimensional modeling apparatus. The storage container 101 in the fourth embodiment is a container in which a space is defined in the storage container 101 and the 3-dimensional modeling powder material (not-shown) including plural types of particles are contained in the space of the in the storage container 101.

In the same manner as the first embodiment to the third embodiment, the storage container 401 has an outer portion having a flexibility. The packaged 3-dimensional modeling powder material 400 in the fourth embodiment further includes the shell box 430 having a rigidity higher than that of the outer portion, outside the outer portion. The shell box 430 has a shape in which an opening is formed at one end and an inner space is defined in the shell box 430 to form a quadrangular prism when the opening is closed with the lid member 431. The outer portion, especially, is arranged inside the shell box 430 during introducing the powder material in the storage container 401. The inner surface of the shell box 430 of the packaged 3-dimensional modeling powder material 400 contacts the outer surface of the outer portion of the storage container 401. The shell box 430, typically, can be structured to be made of a metal. For, example, it is a stainless steel as represented by SUS304.

In FIGS. 4A to 4C, the 3-dimensional modeling powder material (not-shown) contained in the storage container 101 cannot be seen by the shade of the shell box 430. In FIG. 4A, however, in common with the first embodiment to the third embodiment, the 3-dimensional modeling powder material (not-shown) is contained in the storage container 101 having a flexibility. And then, in the state shown in FIG. 4B, the opening inlet 404 is sealed, so that the storage container 101 is closed and sealed by a sealing portion 405. In the state shown in FIG. 4C, the 3-dimensional modeling powder material (not-shown) is compressed by depressurizing the inside of the storage container 401 having a flexibility to deform the storage container 401 in either one of the methods between the first embodiment to the third embodiment. In this process, the outer shape dimensions of the storage container 101 in which the 3-dimensional modeling powder material (not-shown) is contained is defined by the dimensions of the internal shape of the shell box 430 having a high rigidity. The inside of the shell box 430 is closed by closing an inlet opening of the shell box 430 with the lid member 431.

In the packaged 3-dimensional modeling powder material 400, the purpose to provide the shell box 430 having a high rigidity at the outside portion at which modeling powder material is contained in the storage container 401 is to directly supply powder material delivered in a jamming state to a powder material supply container unit of a 3-dimensional modeling apparatus. It is explained, as below.

As shown in FIG. 5, at the side of the powder material supply module 305 for preparing powder material, the modeling module 301 is provided for forming a solid modeling object by emitting laser light, and sintering or both melting and solidifying a modeling powder material, side by side. The roller 304 as a powder material transfer unit is provided at the above portion of the modeling module 301 and the powder material supply module 305 so that the roller 304 is capable to travel back and forth between the modeling module 301 and the powder material supply module 305. In the inside of the modeling module 301, the modeling stage 302 on which the solid modeling object is formed is provided. The modeling stage 302 is connected to the rod 303 of a modeling stage elevating mechanism, to allow to go up and down. The powder material supply module 305 has the powder material supply unit 330 and the powder material supply stage 331 movable with regard to the powder material supply unit 330, in the powder material supply module 305. The upper surface of the powder material supply stage 331 has a plane on which the storage container 401 of the packaged 3-dimensional modeling powder material 400 can be placed. The powder material supply module 305 has a powder material supply stage elevating mechanism which moves the rod 306 connected to the powder material supply stage elevating mechanism up and down. The powder material supply stage 331 is connected to the rod 306 to go up and down by the rod 306.

In FIGS. 4A to 4C, the shape formed by the inner surfaces of the side wall members in a cross-section plane parallel to the bottom member of the shell box 430 has a homothetic shape with the inner shape of a cross-section plane in a horizontal direction of the powder material supply unit 330 of the powder material supply module 305 shown in FIG. 5. The dimensions of the shape formed by the inner surfaces of the side wall members in a cross-section plane parallel to the bottom member of the shell box 430 are designed to be less than the inner shape of the cross-section plane in the horizontal direction of the powder material supply unit by about several millimeters. By this structure, the storage container 401 can be pulled out from the shell box 430 and stored in situ in the powder material supply unit 330 shown in FIG. 5. As described later, at the bottom portion of the powder material supply unit 330, a cutter blade or cutter blades to cut and open the periphery of the bottom portion of the storage container 401 made of a film-type of resin can be provided. By providing the cutter blade or the cutter blades, when the storage container 401 is set in the powder material supply unit 330, the periphery of the bottom portion of the storage container 401 is simultaneously cut off so that the upper portion and the side wall portion of the storage container 401 can be pulled off upward. This embodiment is especially preferable to the case in which powder material is supplied to the powder material supply unit 330 in a state where no powder material remains in the powder material supply unit 330.

The sequences of the modeling processes are to repeat the following the step I to the step IV. In the step I, the modeling stage 302 is moved down by the thickness corresponding to the one layer of the powder material. Next, in the step II, the rod 306 of the powder material supply stage elevating mechanism of the powder material supply stage 331 is moved up so that the one layer of the powder material 307 is pushed up upward from the top end of the powder material supply unit 330 (See FIG. 6A).

And then, in the step III, by using the roller 304, the one layer of the powder material 307 is transferred and surfaced onto the modeling stage 302 of the modeling module 301 from the powder material supply module 305, as the transferred powder material 308 (See FIG. 6B). In the step IV, a solid modeling object is formed by emitting a focused laser light beam onto the surface of the transferred powder material 308 to melt and solidify the transferred powder material 308.

As above, it is described, the system to pull the storage container 401 inside positioned off the shell box 430 and store it in the powder material supply unit 330. In this case, because the shape of the powder material is kept by the storage container 401, the shell box 430 is unnecessary in transportation and storage. By dimensioning the shell box 430 in common with the powder material supply unit 330, however, the shell box 430 is allowed to be combined into a 3-dimensional modeling apparatus as a part of the powder material supply unit 330. In this case, a material of the shell box 430 is chosen to be adaptable to the powder material supply unit 330, and the shell box 430 is manufactured to have sufficient mechanical accuracies in dimensions.

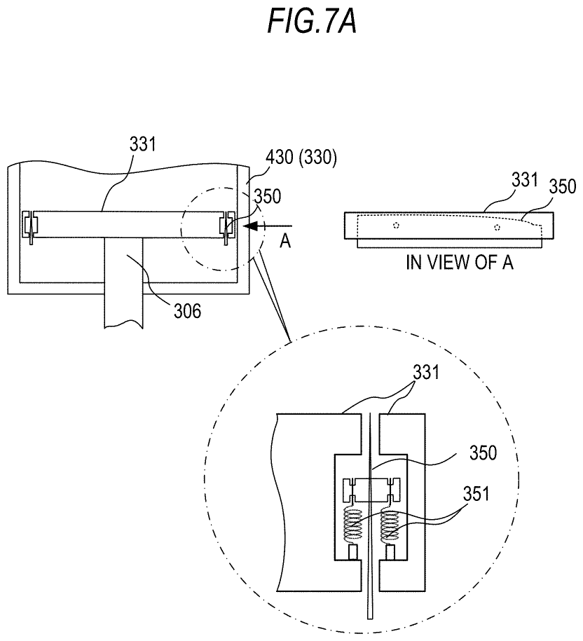

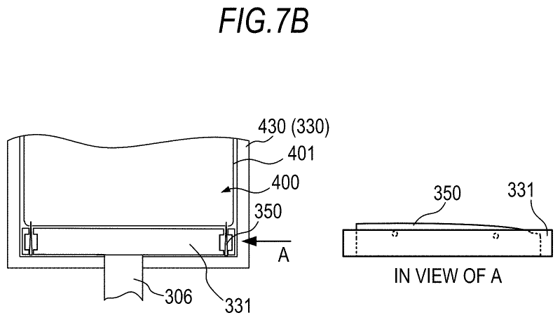

In the case of dimensioning the shell box 430 in common with the powder material supply unit 330, for example, as shown in FIGS. 7A and 7B, it is allowed to provide a mechanism to cut and open the periphery of the bottom portion of the storage container 401. That is, it is allowed to constitute the powder material supply stage 331 to be provided in the shell box 430 such that the powder material supply stage 331 is capable to go up and down and has the cutting blade/cutting blades 350. FIG. 7A shows a state of the powder material supply stage 331 before the packaged 3-dimensional modeling powder material 400 is placed on the powder material supply stage 331 in the case where the cutting blade/cutting blades 350 is provided. FIG. 7B shows a state of the powder material supply stage 331 on which the packaged 3-dimensional modeling powder material 400 is placed, in the case where the cutting blade/cutting blades 350 is provided. In the case where the cutting blade/cutting blades 350 is provided on the powder material supply stage 331, when the shell box 430 is stored in the powder material supply unit 330, the periphery of the bottom portion of the storage container 401 is cut and opened by the cutting blade/cutting blades 350, so that the upper portion and the side wall portion of the storage container 401 can be pulled off upward. In order to function the shell box 430 as the powder material supply unit 330, it is constituted in particular, as follows.

At the inner bottom of the shell box 430, it is to provide, the powder material supply stage 331 not fixed with the side wall members of the shell box 430 and capable to go up and down. The powder material supply stage 331 enrolls a bottom plate of the shell box 430. The powder material supply stage 331 can be connected onto the top of the rod 306 of the powder material supply stage elevating mechanism through a hole made at the bottom portion of the inside of the shell box 430. Once the powder material supply stage 331 is connected to the top of the rod 306, the powder material supply stage 331 moves up and down according to the up-and-down movement of the rod 306. When the rod 306 of the powder material supply stage elevating mechanism moves up, the powder material supply stage 331 also moves up so that the powder material supply stage 331 pushes up the 3-dimensional modeling powder material 110.

The powder material supply stage 331 has a cutting blade/cutting blades 350 at the periphery within the area in which the storage container 400 is placed on the powder material supply stage 331. A cutting blade/cutting blades 350 are provided as one cutting blade or plural pieces of cutting blades with a cutting formation that capable to trim off the surface with which the storage container 400 brings into contact. For example, in the case where the bottom of the storage container 400 is trimmed off by a quadrangular shape, four cutting blades 350 are provided such that the position of each of the four cutting blades 350 corresponds to that of each sides of the quadrangular shape that is trimmed off. The cutting edge of the each of the cutting blades 350 are provided such that the cutting edge extends upward. The cutting blade/cutting blades 350 are urged in a direction in which the rod 306 moves down by the urging member 351 like, for example, a spring (the enlarged portion in FIG. 7A). Also, in the state where the powder material supply stage 331 does not position at the bottom portion of the inside of the shell box 430, as shown in FIG. 7A, the cutting blade/cutting blades 350 is set such that the cutting edge of the cutting blade/cutting blades 350 does not come out upward from the surface of the powder material supply stage 331 on which the storage container 400 is placed. And then, in the state where the powder material supply stage 331 positions at the bottom portion of the inside of the shell box 430, as shown in FIG. 7B, the cutting blade/cutting blades 350 is set such that the cutting edge of the cutting blade/cutting blades 350 is pushed up to the bottom portion of the shell box 430. And then, it can achieve that the cutting edge of the cutting blade/cutting blades 350 projects out upward from the surface of the powder material supply stage 331 on which the storage container 400 is placed. By this, when the storage container 400 is placed on the powder material supply stage 331, simultaneously the bottom of the storage container 401 is cut and opened by the cutting blade/cutting blades 350. Afterward, the upper portion of the storage container 401 is cut and opened to recover the inside of the storage container 401 at atmospheric pressure so that the side surface and the top surface of the storage container 401 is to be pulled off upward. In these steps, it is possible to supply the 3-dimensional modeling powder material 110 into the inside of the powder material supply unit 330 as the shell box 430 in a state where evenness in compositions and particle diameters in manufacturing are kept.

Supplying modeling powder material into general types of 3-dimensional modeling apparatuses is performed by putting a delivered powder material into the powder material supply unit 330. In this process, if modeling powder material includes the powder mixture material having large differences of specific gravities and particle diameters, it likely causes unevenness in compositions in the powder material in transportation.

In addition, by this embodiment, rather than the first embodiment to the third embodiment, it achieves to prevent unevenness in compositions caused in the process of putting a powder material into the powder material supply unit 330 and to supply a modeling powder material to a 3-dimensional modeling apparatus in a state where evenness in compositions and particle diameters in manufacturing are kept.

As above, by using the powder material supplying apparatus in the present invention, accuracy in dimensions, dispersions in qualities and reliabilities in qualities of a solid modeling object can be enhanced.

### Fifth Embodiment

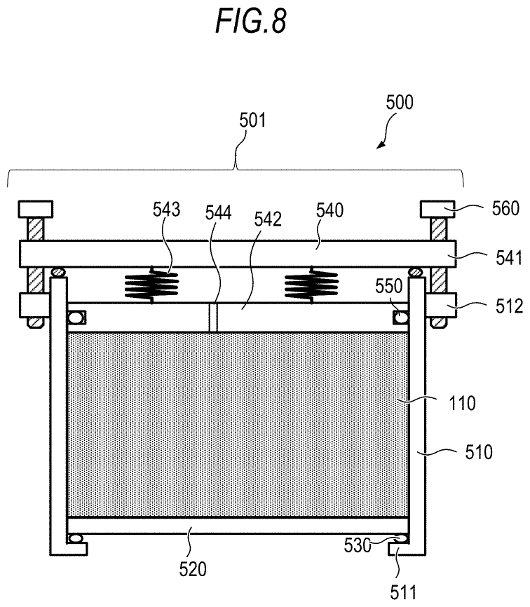

Next, with reference to FIG. 8, it is described, the packaged 3-dimensional modeling powder material 500 as the fifth embodiment. FIG. 8 shows packaged 3-dimensional modeling powder material 500 in the fifth embodiment. The packaged 3-dimensional modeling powder material 500 includes the storage container 501 defining a space inside. The 3-dimensional modeling powder material 101 in which plural types of particles are mixed is contained in the space of the storage container 501 in a compressed (pressured) state.

The storage container 501 has an outer portion and the sealing members 530, 550 that are elastic members. The outer portion includes the side wall members 510, the bottom member 520 and the lid member 540. The storage container 501 can be a closed-vessel whose internal space is closed with the side wall members 510, the bottom member 520, the lid member 540 and the sealing members 530, 550, and capable to be pressured. The side wall members 510 are members defined as walls to form the internal space having quadrangular-shaped openings at both ends. The outer portion is at least partially displaceable. In this embodiment, among the outer portion, a part of one of or both of the bottom member 520 and the lid member 540 includes displaceable members capable of adjusting a relative position. By adjusting a distance between the bottom member 520 and lid member 540 displaceable, the 3-dimensional modeling powder material 110 in the internal space is compressed by the relative position of the bottom member 520 and lid member 540.

The one of the openings defined by the side wall members 510 has the supporting portion 511 to support the bottom member 520 through the sealing member 530. The supporting portion 511 is a structure to project inward from the side wall member 510 as a stopper to prevent the bottom member 520 from falling out outward from the inside. The lid member 540 includes the first lid portion 541 and the second lid portion 542. In the case where the first lid portion 541 is fixed with regard to the side wall members 510, the second lid portion 542 is displaceable with regard to the side wall members 510.

The periphery of the other of the openings defined by the side wall members 510 has the fixing portion 512 to fix the first lid portion 541 among the lid member 540 by the fixing members 560. For example, each of the fixing member 560 has the threaded structure by which each of the fixing member 560 is screw-engageable with the fixing portion 512. One end of the second lid portion 542 is connected to the first lid portion 541 with the elastic members 543. As examples of the elastic members 543, spring members or rubber members are applicable. As a spring member, not only a helical spring shown in FIG. 8 but also various types of springs like a blade spring can be used.

As above, the storage container 501 has a structure in which the internal space is defined by the side wall members 510, the bottom member 520 and the second lid portion 542, the distance between the bottom member 520 and the second lid portion 542 being variable.

Next, it is described, how the storage container 501 is operated. First, in the above-described structure, the bottom member 520 is mounted in the inside of the storage container 501 to close the one of the openings defined by the side wall members 510 such that the supporting portion 511 and the bottom member 520 bind the sealing member 530. And then, the 3-dimensional modeling powder material 110 mounted in the space surrounded by the side wall member 510 and the bottom member 520, and the other of the openings formed by the side wall member 510 is closed with the second lid portion 542.

In this process, the second lid portion 542 is mounted in the inside of the side wall members 510 such that the second lid portion 542 is slidable on the inside surface of the side wall members 510. The first lid portion 541 and the fixing portion 512 of the side wall members 510 are fixed with the fixing member 560. By this, the movement of the second lid portion 542 inside the side wall members 510 with regard to the side wall members 510 is caused by the elastic force of the elastic members 543.

By the displacement of the second lid portion 542, the second lid portion 542 provides a pressure to the 3-dimensional modeling powder material 110 in the storage container 501 so that the 3-dimensional modeling powder material 110 is compressed (pressured) by the second lid portion 542. By structuring each of those members to withstand the pressure provided to the 3-dimensional modeling powder material 110, the state in which the pressure is provided to the 3-dimensional modeling powder material 110 is maintained so that the relative position relationship between the particles composing the 3-dimensional modeling powder material 110 is almost fixed. Also, a sponge-type of a pad (not-shown) having an elasticity can be provided on the under surface of the second lid portion 542. By providing the pad, even in the case where the surfaces of the 3-dimensional modeling powder material 110 introduced in the storage container 501 have irregularities, the whole surfaces of the 3-dimensional modeling powder material 110 can be pressured. In addition, it is desirable to provide the mechanism 544 to release an internal air contained in the storage container 501 to the outside or introduce an external air into the inside for opening the seal, at a part of either one of the side wall members 510, the bottom member 520 and the lid member 540. For example, as the mechanism 544, a check valve that allows to exhaust the internal gas to the outside and prevents the external gas from flowing into the inside of the storage container 501 with another valve to introduce an air from the outside can be optioned.

The sizes of the side wall members 510 and the bottom member 520 are set to have dimensions in which the storage container 501 can be mounted to a powder material supply unit (of the numeral 330 in FIG. 5) of a 3-dimensional modeling apparatus for which the 3-dimensional modeling powder material 110 is used. In detail, the shape formed by the inner surfaces of the side wall members 510 in a cross-section plane parallel to the bottom portion surrounded by the inner surfaces of the side wall members 510 has a homothetic shape with a cross-section shape in a plane in a horizontal direction of the powder material supply unit 330. The dimensions of the shape formed by the inner surfaces of the side wall members 510 in a cross-section plane parallel to the bottom portion surrounded by the inner surface of the side wall members 510 is preferably designed to be the substantially same as or actually less than the inner shape of the cross-section plane in the horizontal direction of the powder material supply unit 330.

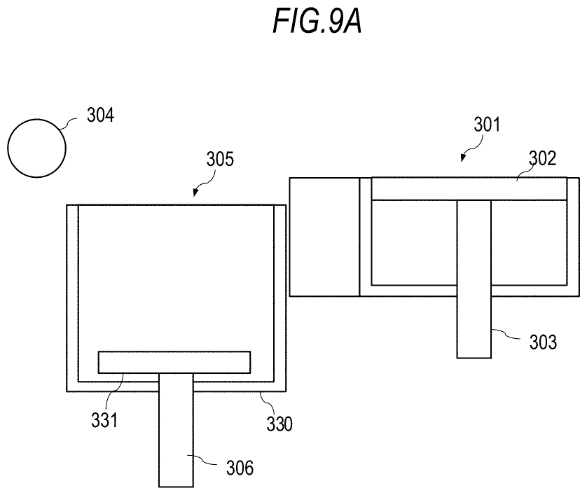

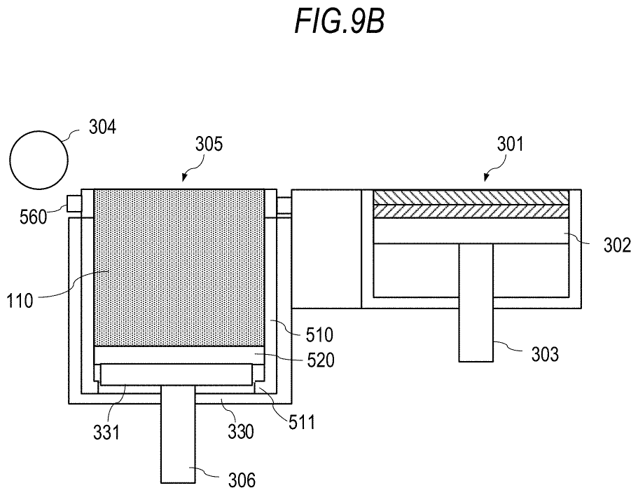

FIGS. 9A and 9B show an example of the 3-dimensional modeling system in which the packaged 3-dimensional modeling powder material 500 is mounted on the 3-dimensional modeling apparatus. FIG. 9A shows the modeling module 301 and the powder material supply module 305 prior to the placement of the packaged 3-dimensional modeling powder material 500. FIG. 9B shows the modeling module 301 and the powder material supply module 305 in the state where the packaged 3-dimensional modeling powder material 500 is mounted. The powder material supply module 305 is dimensioned such that the side wall members 510 are fit in the inside of the powder material supply unit 330. The powder material supply stage 331 is dimensioned to support the bottom member 520 without causing interference with the supporting portion 511 extending to the inside of the storage container 501 from the side wall members 510. The powder material supply stage 331 can move the bottom member 520 up by the rod 305 from the position at which the supporting portion 511 supports the bottom member 520.

The powder material can be pushed up and supplied to the modeling module 301 by removing and opening the lid member 540 and mounting the packaged 3-dimensional modeling powder material 500 into the powder material supply unit 330. By this, after packaging, transporting and storing the 3-dimensional modeling powder material 110, it can be used as is in the process of modeling when it is used for modeling.

When it is used for modeling, the pressure provided to the 3-dimensional modeling powder material 110 is released by loosening the fixing members 560 and mounting the side wall members 510 and the bottom member 520 on the powder material supply unit 330 of the 3-dimensional modeling apparatus after removing the powder material supply unit 330. By controlling the position of the bottom member 520 by the powder material supply stage elevating mechanism of the 3-dimensional modeling apparatus, the necessary amount of the 3-dimensional modeling powder material 110 can be supplied to the upside of the modeling stage 302. When the storage container 501 is mounted, in the case where a gap is created between the powder material supply module 305 and the modeling module 305, a further module to fill the gap between them can be provided.

As long as the 3-dimensional modeling powder material 110 can be compressed (pressured), the structures of the bottom member 520 and the lid member 540 are not restricted to that in FIG. 8, they can be appropriately modified.

In this embodiment, because the 3-dimensional modeling powder material 110 can be mounted onto a 3-dimensional modeling apparatus while keeping the state in which it is packaged as is, accuracy in dimensions and dispersions in qualities of a solid modeling object with high reliability are achieved.

As above, by constituting the 3-dimensional modeling powder material including plural types of particles as the packaged 3-dimensional modeling powder material 500 in this embodiment, it is possible to provide users of 3-dimensional modeling apparatuses is a state in which the uniform mixture state in manufacturing process of the 3-dimensional modeling powder material 110 is kept.

In the above description, although it is explained as applications to 3-dimensional modeling powder materials for 3-dimensional modeling apparatuses, as long as a powder material is a mixture powder material of plural particles in which differences in specific gravities and differences in particle diameters are large, the present invention can be broadly applicable to uses besides the above-described uses.

By the present invention, because a powder material can be provided to usage environment of users in the state where evenness in compositions and particle diameters in manufacturing of powder material are kept, an industrial applicability is widely extendable.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-090418, filed May 25, 2020, and Japanese Patent Application No. 2021-066808, filed Apr. 9, 2021, which are hereby incorporated by reference herein in their entirety.

What is claimed is:

1. A packaged 3-dimensional modeling powder material, comprising:
3-dimensional modeling powder material including plural types of particles; and
a storage container configured to contain the 3-dimensional modeling powder material in an inside of the storage container in a compressed state.

2. A packaged 3-dimensional modeling powder material according to claim 1, comprising an outer portion configured to define a space of the inside of the storage container,
wherein an outer portion is deformable to provide the compressed state to the 3-dimensional modeling powder material.

3. A packaged 3-dimensional modeling powder material according to claim 2, wherein the outer portion has a flexibility,
wherein a pressure of the inside of the storage container is lower than a pressure of the external of the storage container such that the outer portion presses the 3-dimensional modeling powder material.

4. A packaged 3-dimensional modeling powder material according to claim 3, wherein the packaged 3-dimensional modeling powder material has a shell box outside the storage container, the shell box having a higher rigidity than a rigidity of the outer portion of the storage container,
wherein an inside of the shell box brings into contact with an outer surface of the outer portion.

5. A packaged 3-dimensional modeling powder material according to claim 3, wherein the outer portion of the storage container is made of a film-type of resin.

6. A packaged 3-dimensional modeling powder material according to claim 4, wherein the outer portion of the storage container is made of a film-type of resin.

7. A packaged 3-dimensional modeling powder material according to claim 5, wherein the film-type of the resin includes at least one of ethylene-vinyl alcohol copolymerization, polyvinylidene chloride and polyacrylonitrile.

8. A packaged 3-dimensional modeling powder material according to claim 6, wherein the film-type of resin includes at least one of ethylene-vinyl alcohol copolymerization, polyvinylidene chloride and polyacrylonitrile.

9. A packaged 3-dimensional modeling powder material according to claim 5, wherein a surface of the film-type of resin is coated with a coating layer having gas impermeability.

10. A packaged 3-dimensional modeling powder material according to claim 6, wherein a surface of the film-type of resin is coated with a coating layer having gas impermeability.

11. A packaged 3-dimensional modeling powder material according to claim 7, wherein a surface of the film-type of resin is coated with a coating layer having gas impermeability.

12. A packaged 3-dimensional modeling powder material according to claim 8, wherein a surface of the film-type of resin is coated with a coating layer having gas impermeability.

13. A packaged 3-dimensional modeling powder material according to claim 5, wherein a gas permeability ratio of the outer portion is equal to or less than 50 (cc/m²)/day.

14. A packaged 3-dimensional modeling powder material according to claim 6, wherein a gas permeability ratio of the outer portion is equal to or less than 50 (cc/m²)/day.

15. A packaged 3-dimensional modeling powder material according to claim 1, wherein the storage container includes a deoxygenating agent in the inside of the storage container.

16. A packaged 3-dimensional modeling powder material according to claim 1, wherein the outer portion comprising side wall members, a bottom member and a lid member,
wherein the packaged 3-dimensional modeling powder material is in the compressed state by a relative position between the bottom member and the lid member.

17. A packaged 3-dimensional modeling powder material according to claim 16, wherein a shape formed by inner surfaces of the side wall members in a cross-section plane parallel to the bottom member of the shell box has a homothetic shape with an inner shape of a cross-section plane in a horizontal direction of a powder material supply unit of a 3-dimensional modeling apparatus, and a dimension of the shape formed by the inner surfaces of the side wall members in the cross-section plane parallel to the bottom member of the shell box is less than a dimension of the inner shape of the cross-section plane in the horizontal direction of the powder material supply unit.

18. A packaged 3-dimensional modeling powder material, according to claim 1, wherein the plural types of particles have different specific gravities according to each of the plural types.

19. A packaged 3-dimensional modeling powder material, according to claim 1, wherein the plural types of particles have different particle diameters according to each of the plural types.

20. A 3-dimensional modeling system comprising:
a 3-dimensional modeling apparatus including:
a powder material supply module configured to contain a 3-dimensional modeling powder material;
a modeling module configured to form a 3-dimensional object by sintering, or both melting and solidifying the 3-dimensional modeling powder material; and
a powder material transfer unit configured to supply the 3-dimensional modeling powder material from the powder material supply module to the modeling module, and
a packaged 3-dimensional modeling powder material including:
the 3-dimensional modeling powder material including plural types of particles; and
a storage container configured to contain the 3-dimensional modeling powder material in an inside of the storage container in a compressed state, and
wherein prior to supplying the 3-dimensional modeling powder material, the packaged 3-dimensional modeling powder material is placed in the powder material supply module of the 3-dimensional modeling apparatus after releasing the compressed state.
